(19) United States
(12) Patent Application Publication
(10) Pub. No.: US 2016/0230894 A1
(43) Pub. Date: Aug. 11, 2016

(54) METHODS AND DEVICES FOR MAGNETIC FLUID SEALS

(71) Applicant: WHITE RIVER INNOVATION INC., OTTAWA (CA)

(72) Inventors: ISAAC SHANNON, MAYO (CA); JESSE MOON, OTTAWA (CA)

(21) Appl. No.: 14/945,909

(22) Filed: Nov. 19, 2015

Related U.S. Application Data
(60) Provisional application No. 62/112,721, filed on Feb. 6, 2015.

(51) Int. Cl. F16J 15/43; F16J 15/16

(52) U.S. Cl. CPC F16J 15/43; F16J 15/162

(57) ABSTRACT

A system for rotary shaft seals with improved performance with respect to the maximum pressure differential before burst through occurs. The seals exploit discretely or in combination enhanced mechanical geometries, such as helical shaft elements or helical projection outer bodies, and reinforced magnetorheological greases which enclose the shaft providing a seal between the shaft and the permanent magnets within the seal. The reinforced magnetorheological greases comprise a semisolid lubricant, a magnetorheological fluid, and macro-magnetizable particles.

### CROSS-REFERENCE TO RELATED APPLICATION

This patent claims the benefit of priority from U.S. Provisional Patent Application 62/112,721 entitled “Methods and Devices for Magnetic Fluid Seals” filed Feb. 6, 2015, currently pending, the entire contents of which are incorporated herein by reference.

### FIELD OF THE INVENTION

This invention relates to fluidic seals for rotating shafts and more particularly to reinforced magnetorheological sealing systems for such seals.

### BACKGROUND OF THE INVENTION

A mechanical seal (seal) is a device that helps join systems or mechanisms together by preventing leakage, containing pressure, or excluding contamination. The effectiveness of a seal is dependent on adhesion in the case of sealants and compression in the case of gaskets. However, in many instances the seal must maintain its integrity whilst one or more elements within the system or mechanism undergoes motion. One common motion within a wide variety of systems and/or mechanisms is rotation which can be relative motion between parts to configure a system or mechanism but is commonly the rotation of a shaft through another part of the system or mechanism. In many instances the shaft rotation enables power transmission from one part of the system, e.g. the engine, to another, e.g. the gearbox, wheel axle, propeller, etc.

One class of radial shaft seals are lip seals, used to seal rotary elements such as a shaft or rotating bore and common examples include strut seals, hydraulic pump seals, axle seals, power steering seals, and valve stem seals. The seal construction typically consists of a sprung main sealing lip which has a point contact with the shaft. In order to exclude contaminants numerous types of dust lips or exclusionary lips may be used. Another class of radial seals are end face mechanical seal, also referred to as a mechanical face seal but usually simply as a mechanical seal. These seals are typically utilized in rotating equipment, such as pumps, mixers, blowers, and compressors. When operating fluid could leak out of the rotating equipment, e.g. pump, between the rotating shaft and the casing of the equipment. Since the shaft rotates, preventing this leakage can be difficult.

Prior art end face mechanical seal uses both rigid and flexible elements that maintain contact at a sealing interface and slide on each other, allowing a rotating element to pass through a sealed case. The elements are both hydraulically and mechanically loaded with a spring or other device to maintain contact. In other instances the rotating shaft must pass through a wall to prevent fluid on one side of the wall leaking to the other side, e.g. water surrounding a propulsion shaft linking a propeller to an engine. In these situations the seals must operate with a pressure differential that occurs on either side of the seal, e.g. for a surface or submersible craft between the wet side and the dry side. As the pressure differential increases with depth, at a rate for water of approximately 10 kPa (1.45 PSI) per meter, then these seals must have higher pressure differential ratings which increases their cost. Further, within the prior art such improved performance seals are bulkier.

Accordingly, it would be beneficial to provide a means of providing increased performance in pressure differential for a rotary seal without substantially increasing its geometry and/or cost. As a result within the prior art magnetic liquid rotary seals have been the focus of research and development as they to date have offered the potential to leverage these beneficial characteristics within a seal which operates with no, or very low, maintenance and extremely low leakage in a very wide range of applications. Of these ferrofluidic seals are amongst the most common and are most often packaged in mechanical seal assemblies called rotary feed-throughs, which also contain a central shaft, ball bearings and an outer housing. The ball bearings provide two important functions: maintaining the shaft's centering within the seal gap, and supporting external loads. The bearings are the only mechanical wear-items, as the dynamic seal is actually a series of rings made of ultra-low vapor pressure, oil-based liquid held magnetically between the rotor and stator. Therefore the operating life and equipment maintenance cycles are generally very long, and the drag torque very low. The magnet material is permanently charged and requires no electrical power or other re-energizing or maintenance. In addition to ferrofluidic fluids MAGREFs may be employed in seals although to date their use has been comparatively limited.

The basic difference between ferrofluids and magnetorheological (MR) fluids (MAGREFs) is the size of the particles. The particles within a ferrofluid primarily consist of nanoparticles which are suspended by Brownian motion within a base carrier fluid and generally will not settle out under normal conditions. MAGREF particles on the other hand primarily consist of micrometre-scale particles which are too heavy for Brownian motion to keep them suspended within a base carrier fluid, and thus will settle over time because of the inherent density difference between the particle and its carrier fluid. These two fluids have very different applications as a result.

Ferrofluidically sealed feed-throughs offer performance levels that other technologies can't achieve, by optimizing features such as ferrofluid viscosity and magnetic strength, magnet and steel materials, bearing arrangements, and water cooling for applications with extremely high speeds or temperatures. However, despite the benefits ferrofluidic seals have brought to date their complexity still increases significantly to provide high pressure differentials due to the characteristics of the ferrofluids. In contrast MAGREFs have to date found application primarily in applications where it would be desirable to control the apparent viscosity of the MAGREF such as dampers, brakes, clutches, and valves, see for example Wang, et al in “MAGREF Devices: Principles, Characteristics and Applications in Mechanical Engineering” (J. Materials Design and Applications, Vol. 215(3), pp. 165-174). This is despite initial research demonstrating increased pressure resistance, see for example Kordonsky et al. in “MAGREF Based Seal” (Proc. 5^{th} Int. Conf. ER Fluids, MR Suspensions, and Associated Technology, pp. 709-715).

Accordingly, the inventors have established improved seal designs and novel reinforced magnetorheological (MR) greases for both prior art and improved seal structures that further increase the maximum pressure of MR seals, known as the burst pressure, with the largest improvements arising from improved seal designs exploiting a novel reinforced MR grease.

Other aspects and features of the present invention will become apparent to those ordinarily skilled in the art upon review of the following description of specific embodiments of the invention in conjunction with the accompanying Figures.

### SUMMARY OF THE INVENTION

It is an object of the present invention to mitigate drawbacks within the prior art relating to fluidic seals for rotating shafts and more particularly to reinforced magnetorheological sealing systems for such seals.

In accordance with an embodiment of the invention there is provided a seal comprising a grease established by mixing a semisolid lubricant and a plurality of macro-magnetizable particles.

In accordance with an embodiment of the invention there is provided a grease for use in magnetic seals established by mixing a semisolid lubricant and a plurality of macro-magnetizable particles.

In accordance with an embodiment of the invention there is provided a seal for a shaft comprising:
an outer body through which the shaft is designed to fit comprising an inner surface and an external surface, the inner surface comprising a plurality of helical projections with predetermined cross-section;
a magnet disposed within a predetermined position within the outer body, the magnet for radially encompassing the shaft; and
a magnetorheological grease.

In accordance with an embodiment of the invention there is provided a seal for a shaft comprising:
an outer body through which the shaft is designed to fit comprising an inner surface and an external surface;
a magnet disposed within a predetermined position within the outer body, the magnet for radially encompassing the shaft;
a helical sleeve having an outer surface comprising a plurality of helical projections with predetermined cross-section; and
a grease.

In accordance with an embodiment of the invention there is provided a seal for a shaft comprising:
an outer body through which the shaft is designed to fit comprising an inner surface and an external surface, the inner surface comprising a plurality of first helical projections with a first predetermined cross-section;
a helical sleeve having an outer surface comprising a plurality of second helical projections with a second predetermined cross-section;
a magnet disposed within a predetermined position within the outer body, the magnet for radially encompassing the shaft; and a grease.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached Figures, wherein:

FIG. 1 depicts a perspective view of one embodiment of a remote operated vehicle (ROV) thruster utilizing a seal comprising a REMROG material and/enhanced seal design according to an embodiment of the invention;

FIG. 2 depicts a diagrammatic cross-section of a motor housing according to an embodiment of the invention;

FIG. 3 depicts a diagrammatic cross-section of a REMROG seal 300 according to an embodiment of the invention;

FIG. 4 depicts a diagrammatic cross-section of a REMROG seal according to an embodiment of the invention wherein the REMROG has magnetizable fibers;

FIGS. 5A and 5B depict schematically at different stages of deconstruction a REMROG seal according to an embodiment of the invention;

FIGS. 6A through 6F depict schematically at different stages of deconstruction a REMROG seal according to an embodiment of the invention exploiting a spirally profiled shaft;

FIG. 7A through 7D depict schematically at different stages of deconstruction a REMROG seal according to an embodiment of the invention exploiting spirally profiled elements around a cylindrical shaft;

FIG. 8 depicts a cross-section of a REMROG seal according to an embodiment of the invention exploiting spirally profiled shaft;

FIG. 9 depicts a cross-section of a REMROG seal according to an embodiment of the invention exploiting spirally profiled outer housing; and

FIGS. 10 to 12 depict cross-sections of REMROG seals according to embodiments of the invention;

FIG. 13 depicts a traditional cylindrical ball bearing:

FIG. 14 depicts a magnetic cylindrical bearing according to an embodiment of the invention;

FIG. 15 depicts a magnetic cylindrical bearing according to an embodiment of the invention with the outer race partially removed;

FIG. 16 depicts a magnetic array and paramagnetic material forming elements of a magnetic seal according to an embodiment of the invention; and

FIG. 17 depicts a close-up side view of the gap between the magnet array and paramagnetic material within the design of FIG. 16 where the magnetorheological gel will be attracted.

### DETAILED DESCRIPTION

The present invention is directed to fluidic seals for rotating shafts and more particularly to reinforced magnetorheological sealing systems for such seals.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

Magnetorheological Fluid: Fluid compositions that undergo a change in apparent viscosity in the presence of a magnetic field are referred to as Bingham magnetic fluids or magnetorheological fluids (MAGnetoRhEological Fluids—MAGREFs). These MAGREFs may include magnetizable particles dispersed or suspended within a carrier fluid. In the presence of a magnetic field, the magnetizable particles become polarized and are thereby organized into chains of particles within the carrier fluid. The chains of particles act to increase the apparent viscosity or flow resistance of the fluid composition resulting in the development of a solid mass having a yield stress that must be exceeded to induce onset of flow of the MAGREF (MAGREF).

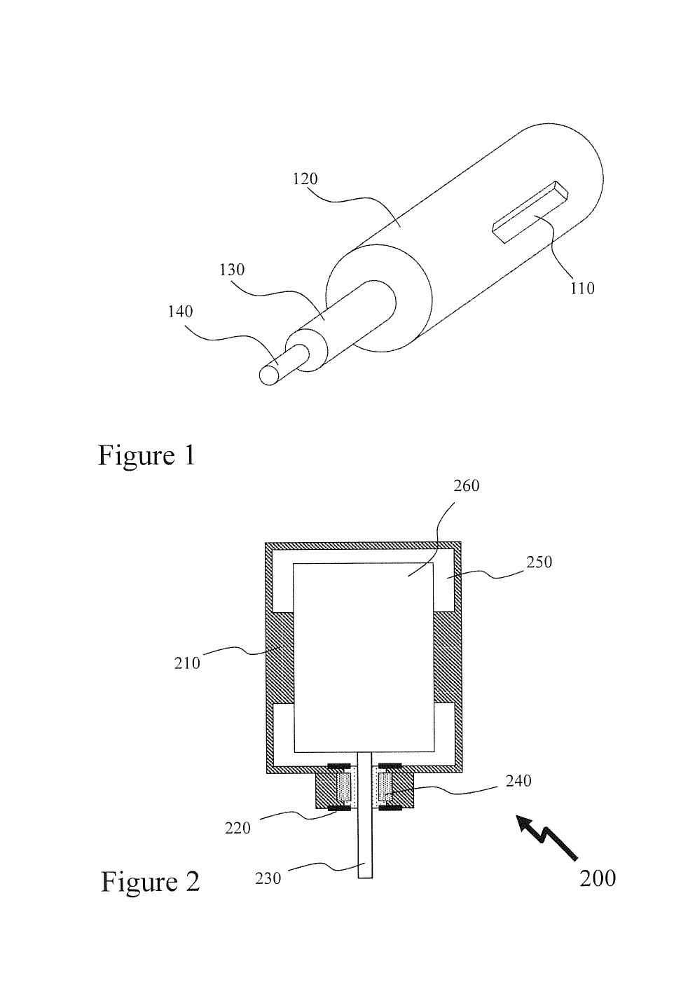

The magnetizable particles within a MAGREF are in many instances symmetrical and have aspect ratios of about 1 to about 1.5. Examples of such particles include, but are not limited to, spheres, ellipsoids, and cuboids. However, in other MAGREFs the magnetizable particles may have a higher aspect ratio, i.e. an aspect ratio greater than 1.5. For a three dimensional particle, the aspect ratio is the ratio of the largest dimension to the smallest dimension. The high aspect ratio magnetizable particles will generally align with an applied magnetic field. Accordingly, when the applied field is perpendicular to the direction within which the MAGREF wishes to flow then the result is an effective increase in viscosity. In contrast, alignment of the high aspect ratio particles in the flow direction will promote a decrease in viscosity. As depicted and described below in respect of embodiments of the invention within FIGS. 1 through 12 the magnetic field with seals according to embodiments of the invention is primarily perpendicular to the axis of a shaft forming part of a feedthrough comprising the seal and hence this magnetic field is perpendicular to the axis along which a pressure differential either side of the seal will be seeking to push the MAGREF from the seal causing it to burst. Accordingly, MAGREFs with high aspect ratio particles behave differently to MAGREFs with low aspect ratio particles, for example. As a result MAGREF compositions containing high aspect ratio particles may demonstrate yield stress 2 to 10 times higher when compared with MAGREF compositions containing low aspect ratio particles alone.

Beneficially, this allows for the production of MAGREF devices that are smaller yet produce the same level of force as produced by larger devices that contain MAGREFs with only low aspect ratio particles. Thus, MAGREFs containing high aspect ratio particles can thus be used to build devices that offer improved performance and/or smaller than those devices that use MAGREFs with only low aspect ratio particles. To obtain these benefits, the MAGREF can consist essentially of high aspect ratio particles or may contain a mixture of high aspect and low aspect ratio particles. Upon alignment, the high aspect ratio particles form chains or networks of high aspect ratio particles whose orientation facilitates an increase in viscosity. Because of their geometry, the use of high aspect ratio particles permits the use of a smaller number of total magnetizable particles in the MAGREF composition when compared with a MAGREF composition that contains only low aspect ratio particles. Since the increase in viscosity can be achieved with a smaller number of magnetizable particles, MAGREF devices containing the MAGREF composition can be reduced in size when compared with devices that contain MAGREF compositions that contain only low aspect ratio particles. Within other MAGREF compositions reversible or non-reversible interlocking structures may be part of the magnetizable particles. These interlocking structures may produce higher strength chains or networks upon alignment when compared with chains or networks that are formed from particles that are not provided with such interlocking structures. The particles that contain the interlocking structures can have high aspect ratios (i.e., have an aspect ratio that is greater than 1.5) or alternatively can be low aspect ratios (i.e., have an aspect ratio that is less than or equal to 1.5). High aspect ratio magnetizable particles may be of one geometry or they may be of a plurality of different shapes. For example, high aspect ratio particles may be linear, curled, crimped, bent, twisted, or have any combination thereof that comprises at least one of the foregoing shapes together with other geometries.

As noted above, high aspect ratio particles as well as the low aspect ratio particles can be provided with reversible interlocking structures that generally comprise a male component and a female component although unisex (androgynous) designs are also possible. The male component is generally accepted into the female component, thereby facilitating the interlocking, and may comprise structures generally shaped in the form of protrusions on the surface of the magnetizable particles such as hooks, spikes, fins, teeth, etc. Examples of suitable female interlocking structures are holes, pores, notches, grooves, etc. Provisioning of fins and notches on the same end may provide androgynous magnetizable particle. Any magnetizable particle having an interlocking structure may have a male component, such as one or more of the above described male interlocking structures; or a female component adapted to receive a male component, such as one or more of the above described female interlocking structures; or a combination of male and female components. Multiple interlocking structures may be provided to increase the likelihood of interlocking. Thus, a MAGREF composition is generally formulated to provide magnetizable particles that are distributed in a carrier fluid (or carrier medium).

In other embodiments of the invention the MAGREF may be combinations of high and low aspect ratio particles, which may or may not have interlocking capabilities. The proportions of high aspect ratio magnetizable particles and low aspect ratio magnetizable particles with interlocking structures may vary from highly asymmetric weight ratios through to balanced ratios, e.g. from about 1:100 to about 100:1.

The MAGREF composition generally comprises magnetizable particles, a carrier fluid and optionally one or more additives. The magnetizable particles of the MAGREF composition may be comprised of, for example, paramagnetic, superparamagnetic, ferromagnetic compounds, or a combination comprising at least one of the foregoing compounds. Examples of specific magnetizable particles are particles comprised of materials such as iron, iron oxide, iron nitride, iron carbide, carbonyl iron, chromium dioxide, low carbon steel, silicon steel, nickel, cobalt, or the like, or a combination comprising at least one of the foregoing. The iron oxide includes all forms of pure iron oxide, such as, for example, Fe2O3 and Fe3O4, as well as those containing small amounts of other elements, such as, manganese, zinc or barium. Specific examples of iron oxide include ferrites and magnetites. In addition, the magnetizable particles can be comprised of alloys of iron, such as, for example, those containing aluminum, silicon, cobalt, nickel, vanadium, molybdenum, chromium, tungsten, manganese, copper, or a combination comprising at least one of the foregoing metals.

The magnetizable particles can also be comprised of specific iron-cobalt and iron-nickel alloys. The iron-cobalt alloys have an iron to cobalt ratio ranging from about 30:70 to about 95:5. In one embodiment, the iron-cobalt alloys can have an iron to cobalt ratio ranging from about 50:50 to about 85:15. The iron-nickel alloys have an iron to nickel ratio ranging from about 90:10 to about 99:1. In one embodiment, the iron-nickel alloys can have an iron to cobalt ratio ranging from about 94:6 to about 97:3.

The aforementioned iron-cobalt and iron-nickel alloys may also contain a small amount of additional elements, such as, for example, vanadium, chromium, or the like, in order to improve the ductility and mechanical properties of the alloys. These additional elements are typically present in an amount that is less than about 3.0% by weight, based on the total weight of the magnetizable particles.

The magnetizable particles are generally obtained from processes involving the reduction of metal oxides, grinding or attrition, electrolytic deposition, metal carbonyl decomposition, rapid solidification, or smelt processing. Examples of suitable metal powders that are commercially available are straight iron powders, reduced iron powders, insulated reduced iron powders, cobalt powders, or the like, or a combination comprising at least one of the foregoing metal powders. Alloy powders can also be used.

The low aspect ratio magnetizable particles with interlocking structures have a low aspect ratio of 1 to 1.5. An exemplary low aspect ratio particle is one that has an aspect ratio of about 1. Examples of suitable low aspect ratio particles that have interlocking structures are spherical particles ellipsoidal particles, conical particles, cuboidal particles, polygonal particles, or the like. The low aspect ratio magnetizable particles with interlocking structures generally have an average particle size of about 0.1 micrometers to about 500 micrometers. In one embodiment, the low aspect ratio magnetizable particles have an average particle size of about 1 micrometers to about 250 micrometers. In another embodiment, the low aspect ratio magnetizable particles have an average particle size of about 10 micrometers to about 100 micrometers. The low aspect ratio magnetizable particles with interlocking structures may have a bimodal particle size distribution, a uniform particle size distribution, or a random particle size distribution.

The high aspect ratio magnetizable particles are those having an aspect ratio of greater than 1.5. These high aspect ratio magnetizable particles may therefore exist in the form of whiskers, needles, rods, tubes, strands, elongated platelets, lamellar platelets, ellipsoids, wires, micro fibers, nanofibers and nanotubes, elongated fullerenes, or the like, or a combination comprising at least one of the foregoing. The high aspect ratio magnetizable particles may also have shapes that are combinations of the shapes of high aspect ratio particles and low aspect ratio particles. For example, a suitable example of a high aspect ratio magnetizable particle that has a combined shape is one where a spherical particle is disposed upon a high aspect ratio magnetizable particle, at any point along the length of the high aspect ratio particle. In general the high aspect ratio magnetizable particles can have cross sections that have any desirable geometry. Examples of suitable geometries are square, rectangular, triangular, circular, elliptical, polygonal, or a combination comprising at least one of the foregoing geometries. The high aspect ratio particles can be nanoparticles or particles having dimensions in the micrometer range. High aspect ratio nanoparticles are those having at least one average dimension that is less than or equal to about 1,000 nanometers.

Micrometer sized high aspect ratio magnetizable particles are those having the smallest dimension greater than about 1 micrometer. In one embodiment, micrometer sized high aspect ratio magnetizable particles are those having the smallest dimension greater than or equal to about 10 micrometers. In another embodiment, micrometer sized high aspect ratio magnetizable particles are those having the smallest dimension greater than or equal to about 100 micrometers.

As previously noted, the aspect ratio of the high aspect ratio magnetizable particles is greater than 1.5. In one embodiment, the aspect ratio of the high aspect ratio magnetizable particles is greater than 2. In another embodiment, the aspect ratio of the high aspect ratio magnetizable particles is greater than 5. In yet another embodiment, the aspect ratio of the high aspect ratio magnetizable particles is greater than 10. In yet another embodiment, the aspect ratio of the high aspect ratio magnetizable particles is greater than 100. In yet another embodiment, the aspect ratio of the high aspect ratio magnetizable particles is greater than 1,000. In yet another embodiment, the aspect ratio of the high aspect ratio magnetizable particles is greater than 10,000.

The number of magnetizable particles in the MAGREF composition generally depends upon the desired magnetic activity and viscosity of the fluid, but may, for example, range from very low percentages, e.g. 0.01 volume percent or less, to high percentages, e.g. 75 volume percent or more. It may also be from about 0.01 to about 60 volume percent of the carrier fluid, based on the total volume of the MAGREF composition. In one embodiment, the number of magnetizable particles in the MAGREF composition can be from about 1.5 to about 50 volume percent, based on the total volume of the MAGREF composition.

The carrier fluid forms a continuous phase of the MAGREF composition. Examples of suitable carrier fluids are natural fatty oils, mineral oils, polyolefins, polyphenylethers, polyesters (such as perfluorinated polyesters, dibasic acid esters and neopentylpolyol esters), phosphate esters, synthetic cycloparaffin oils and synthetic paraffin oils, unsaturated hydrocarbon oils, monobasic acid esters, glycol esters and ethers (such as polyalkylene glycol), synthetic hydrocarbon oils, perfluorinated polyethers, halogenated hydrocarbons, or the like, or a combination comprising at least one of the foregoing carrier fluids.

Exemplary carrier fluids are those which are non-volatile, non-polar and do not contain amounts of water greater than or equal to about 5 wt %, based upon the total weight of the carrier fluid. Examples of hydrocarbons are mineral oils, paraffins, or cycloparaffins. Synthetic hydrocarbon oils include those oils derived from oligomerization of olefins such as polybutenes and oils derived from high molecular weight alpha olefins.

The MAGREF composition can optionally include other additives such as a thixotropic agent, a carboxylate soap, an antioxidant, a lubricant, a viscosity modifier or a combination comprising at least one of the foregoing additives. Exemplary thixotropic agents include polymer-modified metal oxides. The polymer-modified metal oxide can be prepared by reacting a metal oxide powder with a polymeric compound that is compatible with the carrier fluid and capable of shielding substantially all of the hydrogen-bonding sites or groups on the surface of the metal oxide from any interaction with other molecules. Examples of suitable metal oxide powders include precipitated silica gel, fumed or pyrogenic silica, silica gel, titanium dioxide, and iron oxides such as ferrites or magnetites, or the like, or a combination comprising at least one of the foregoing metal oxide powders.

Examples of suitable polymeric compounds useful in forming the polymer-modified metal oxides include thermosetting polymers, thermoplastic polymers or combinations of thermosetting polymers with thermoplastic polymers. Examples of polymeric compounds are oligomers, polymers, copolymers such as block copolymers, star block copolymers, terpolymers, random copolymers, alternating copolymers, graft copolymers, or the like, dendrimers, ionomers, or the like, or a combination comprising at least one of the foregoing. Examples of suitable polymers are polyacetals, polysiloxanes, polyurethanes, polyolefins, polyacrylics, polycarbonates, polyalkyds, polystyrenes, polyesters, polyamides, polyaramides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polysiloxanes, phenolics, epoxies, or combinations comprising at least one of the foregoing organic polymers.

Examples of the carboxylate soap include lithium stearate, calcium stearate, aluminum stearate, ferrous oleate, ferrous stearate, zinc stearate, sodium stearate, strontium stearate, or the like, or a combination comprising at least one of the foregoing carboxylate soaps. The viscosity of the MAGREF composition is generally dependent upon the specific use to which it is applied.

In one embodiment, in one method of manufacturing the MAGREF composition, the low aspect ratio interlocking particles and/or the high aspect ratio particles (which can optionally be interlocking), the carrier fluid and desired additives are taken and mixed in a suitable mixing device to form a suitable mixture. If desired, the mixing may be conducted at an elevated temperature of greater than or equal to about 50° C. The mixing can take place in a device that uses shear force, extensional force, compressive force, ultrasonic energy, electromagnetic energy, thermal energy or combinations comprising at least one of the foregoing forces and energies and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, screen packs, rolls, rams, helical rotors, or combinations comprising at least one of the foregoing. Exemplary mixing devices are extruders such as single screw and twin screw extruders, buss kneaders, helicones, ball mixers, Eirich mixers, Waring blenders, Henschel mixers, or the like.

Reinforced Magnetorheological Grease: Within embodiments of the invention enhanced magnetorheological fluid seals are presented within the descriptions presented below in respect of FIGS. 1 through 12. Within some of these embodiments the physical geometry of the seal is adjusted to improve their performance. Within other embodiments of the invention enhanced magnetorheological sealing materials are employed either discretely or in combination with these enhanced physical geometry variants. The inventors describe these enhanced magnetorheological sealing materials as REinforced MagnetoRheOlogical Grease (REMROG).

A REMROG comprise, a MAGnetoRhEologic Fluid (MAGREF) in combination with a semisolid lubricant and macro-magnetizable particles. A semisolid lubricant, also known as a grease or wax according to its chemical composition. Waxes are a class of chemical compounds that are plastic (malleable) near ambient temperatures and may be animal derived, plant derived, as well as those derived from petroleum and oil. Examples of petroleum and oil based waxes (or semisolid lubricants) include, but are not limited to, paraffin waxes comprising mixtures of saturated n- and isoalkanes, naphthenes, and alkyl- and naphthene-substituted aromatic compounds as well as those derived from cracking polyethylene. Plant waxes are generally mixtures of substituted long-chain aliphatic hydrocarbons, containing alkanes, fatty acids, primary and secondary alcohols, diols, ketones, aldehydes.

Greases in contrast are generally a soap emulsified with mineral or vegetable oil. A characteristic feature of greases is that they possess a high initial viscosity, which upon the application of shear, drops to give the effect of an oil-lubricated bearing of approximately the same viscosity as the base oil used in the grease. A true grease consists of an oil and/or other fluid lubricant that is mixed with a thickener, typically a soap, to form a solid or semisolid. Soaps are a common emulsifying agent used, and the selection of the type of soap is determined by the application. Soaps may include calcium stearate, sodium stearate, lithium stearate, as well as mixtures of these components. Fatty acids derivatives other than stearates are also used, especially lithium 12-hydroxystearate. The nature of the soaps influences the temperature resistance (relating to the viscosity), water resistance, and chemical stability of the resulting grease. Powdered solids may also be used as thickeners, especially as clays, which are used in some inexpensive, low performance greases. Fatty oil-based greases have also been prepared with other thickeners, such tar, graphite, or mica, which also increase the durability of the grease.

In other greases so-called Solid Lubricating Additives (SLAs) are added to some greases to improve their lubricating properties. Some greases may operate under extreme pressure wherein under high pressure or shock loading a normal grease may be compressed to the extent that the greased parts come into physical contact, causing friction and wear. Extreme pressure greases contains solid lubricants, typically graphite and/or molybdenum disulfide, to provide protection under heavy loadings. These solid lubricants generally bond to a metallic surface preventing metal-to-metal contact and the resulting friction and wear when the lubricant film gets too thin.

Macro-Magnetizable Particles: Within a REMROG according to embodiments of the invention the semisolid lubricant and MAGREF are mixed according to a predetermined volumetric ratio or weight percentage together with macro-magnetizable particles (MMPs). According to embodiments of the invention such MMPs may be low aspect ratio, medium aspect ratio, or high aspect ratio magnetizable particles having a smallest dimension greater than or equal to about 100 micrometers. In another embodiment, micrometer sized high aspect ratio magnetizable particles are those having the smallest dimension greater than or equal to about 1,000 micrometers. However, high aspect ratio MMPs may provide benefit through supporting intermeshing of the MMPs form a loosely interconnected three-dimensional continuous and/or discontinuous “mesh”.

The magnetizable particles of an MMP composition may be comprised of, for example, paramagnetic, superparamagnetic, ferromagnetic compounds, or a combination comprising at least one of the foregoing compounds. Examples of specific magnetizable particles are particles comprised of materials such as iron, iron oxide, iron nitride, iron carbide, carbonyl iron, chromium dioxide, low carbon steel, silicon steel, nickel, cobalt, or the like, or a combination comprising at least one of the foregoing. The iron oxide includes all forms of pure iron oxide, such as, for example, Fe2O3 and Fe3O4, as well as those containing small amounts of other elements, such as, manganese, zinc or barium. Specific examples of iron oxide include ferrites and magnetites. In addition, the magnetizable particles can be comprised of alloys of iron, such as, for example, those containing aluminum, silicon, cobalt, nickel, vanadium, molybdenum, chromium, tungsten, manganese, copper, or a combination comprising at least one of the foregoing metals.

The magnetizable particles can also be comprised of specific iron-cobalt and iron-nickel alloys. The iron-cobalt alloys have an iron to cobalt ratio ranging from about 30:70 to about 95:5. In one embodiment, the iron-cobalt alloys can have an iron to cobalt ratio ranging from about 50:50 to about 85:15. The iron-nickel alloys have an iron to nickel ratio ranging from about 90:10 to about 99:1. In one embodiment, the iron-nickel alloys can have an iron to cobalt ratio ranging from about 94:6 to about 97:3.

The aforementioned iron-cobalt and iron-nickel alloys may also contain a small amount of additional elements, such as, for example, vanadium, chromium, or the like, in order to improve the ductility and mechanical properties of the alloys. These additional elements are typically present in an amount that is less than about 3.0% by weight, based on the total weight of the magnetizable particles.

The magnetizable particles are generally obtained from processes involving the reduction of metal oxides, grinding or attrition, electrolytic deposition, metal carbonyl decomposition, rapid solidification, or smelt processing. Examples of suitable metal powders that are commercially available are straight iron powders, reduced iron powders, insulated reduced iron powders, cobalt powders, or the like, or a combination comprising at least one of the foregoing metal powders. Alloy powders can also be used.

Exemplary REMROG #1: According to an embodiment of the invention for a low cost REMROG is a conventional ferrofluid MAGREF which is mixed with a hydrous calcium thickener based petroleum grease with polymer fortification, paraffin wax, and steel fibers. The steel fibers being standard commercial steel fibers, such as found in steel wool, with a diameter of approximately 65 μm (0.0635 mm or 25 thousands of an inch). Such a conventional ferrofluid MAGREF may for example comprise 2-15% iron oxide powder with a nominal diameter of 10 nm dispersed within an oil soluble dispersant and a carrier liquid, either polar or non-polar. The dispersant is an agent which attaches to the surface of the magnetic particles to physically separate the particles from each other. Typical dispersing agents, or dispersants, are molecules which have a polar “head” or anchor group which attaches to the magnetic particle and a “tail” which extends outwardly from the particle surface.

Illustrative examples of polar carrier liquids in which stable suspensions of magnetic particles may be formed include any of the ester plasticizers for polymers such as vinyl chloride resins. Suitable polar carrier liquids include: polyesters of saturated hydrocarbon acids, such as C₆ -C₁₂ hydrocarbon acids; phthalates, such as dioctyl and other dialkyl phthalates; citrate esters; and trimellitate esters, such as tri(n-octyl/n-decyl) esters. Other suitable polar carriers include: phthalic acid derivatives, such as dialkyl and alkylbenzyl orthophthalates; phosphates, such as triaryl, trialkyl or alkylaryl phosphates; and epoxy derivatives, such as epoxidized soybean oil. Nonpolar carrier liquids useful in the practice of the present invention include hydrocarbon oils, in particular, poly(alpha olefin) oils of low volatility and low viscosity. Such oils are readily available commercially.

Exemplary REMROG #2: According to an embodiment of the invention for a low cost REMROG is a conventional ferrofluid MAGREF, such as described supra, which is mixed with a hydrous calcium thickener based petroleum grease with polymer fortification, paraffin wax, and powdered iron oxide.

Exemplary REMROG #3: According to an embodiment of the invention for a low cost REMROG is an epoxy resin which is mixed with a calcium thickener and powdered iron oxide. The percentages of resin being 30-40%, calcium carbonate 40-50%, and iron powder 10-20%.

Exemplary REMROG #4: According to an embodiment of the invention for a low cost REMROG is an epoxy resin which is mixed with a calcium thickener, powdered iron oxide, and steel fibers. The percentages of resin being 30-40%, calcium carbonate 40-50%, and iron powder 10-20%. To the epoxy resin 5-20% by weight of steel fibers are added. The steel fibers being standard commercial steel fibers, such as found in steel wool, with a diameter of approximately 65 μm (0.0635 mm or 25 thousands of an inch).

Exemplary REMROG #5: According to an embodiment of the invention for a low cost REMROG a dilatant material is mixed with powdered iron oxide. A first dilatant material being formed by mixing silicone oil with boric acid whilst another comprises silica nanoparticles dispersed within poly(ethylene) glycol.

Exemplary REMROG #6: According to an embodiment of the invention for a low cost REMROG a dilatant material is mixed with powdered iron oxide. A first dilatant material being formed by mixing silicone oil with boric acid whilst another comprises silica nanoparticles dispersed within poly(ethylene) glycol. To the dilatant material 5-20% by weight of steel fibers are added. The steel fibers being standard commercial steel fibers, such as found in steel wool, with a diameter of approximately 65 μm (0.0635 mm or 25 thousands of an inch).

Suitable greases for REMROGs according to embodiments of the invention are those with National Lubricating Grease Institute (NLGI) consistency numbers between 00 and 3. The NLGI consistency number (sometimes called “NLGI grade”) expresses a measure of the relative hardness of a grease used for lubrication. The MMP fiber content as specified by the standard classification of lubricating grease established by the National Lubricating Grease Institute (NLGI) may be between 10 to 70 percent by weight. Beneficially the inventors have also established that a REMROG enhances centering of the motor shaft in relation to the permanent magnets in cases where force is applied to the motor shaft in a direction perpendicular to its axis.

MAGNETS: Within embodiments of the invention magnets provide the required magnetic field for use in conjunction with the MAGREFs and REMROGs to provide the seals according to embodiments of the invention. The magnetic field(s) may be generated through the use of permanent magnets or electromagnets although in many instances to remove the requirement for an electrical power connection to the seal permanent magnets are employed. A permanent magnet is an object made from a material that is magnetized and creates its own persistent magnetic field. Because of the way their regular crystalline atomic structure causes their spins to interact, some metals are ferromagnetic when found in their natural states, as ores. These include iron ore (magnetite or lodestone), cobalt and nickel.

Commercial permanent magnets are generally ceramic, or ferrite, magnets and are made of a sintered composite of powdered iron oxide and barium/strontium carbonate ceramic. Given the low cost of the materials and manufacturing methods, inexpensive magnets of various shapes can be easily mass-produced. The resulting magnets are non-corroding but brittle and must be treated like other ceramics.

Alnico magnets are made by casting or sintering a combination of aluminium, nickel and cobalt with iron and small amounts of other elements added to enhance the properties of the magnet. Sintering offers superior mechanical characteristics, whereas casting delivers higher magnetic fields and allows for the design of intricate shapes. Alnico magnets resist corrosion and have physical properties more forgiving than ferrite, but not quite as desirable as a metal. Injection-molded magnets are a composite of various types of resin and magnetic powders, allowing parts of complex shapes to be manufactured by injection molding. The physical and magnetic properties of the product depend on the raw materials, but are generally lower in magnetic strength and resemble plastics in their physical properties.

Rare-earth magnets are strong permanent magnets made from alloys of rare earth elements. Rare-earth magnets are the strongest type of permanent magnets made, producing significantly stronger magnetic fields than other types such as ferrite or alnico magnets. The magnetic field typically produced by rare-earth magnets can be in excess of 1.4 teslas, whereas ferrite or ceramic magnets typically exhibit fields of 0.5 to 1 tesla. There are two types: neodymium magnets and samarium-cobalt magnets. Rare earth magnets are extremely brittle and also vulnerable to corrosion, so they are usually plated or coated to protect them from breaking, chipping, or crumbling into powder.

FIGURES: Embodiments of the invention are described below in respect of FIGS. 1 through 9 respectively. Referring to FIG. 1 there is depicted a perspective view of one embodiment of a remote operated vehicle (ROV) thruster utilizing a seal comprising a reinforced MR grease and/enhanced seal design according to an embodiment of the invention. Within the embodiment depicted in FIG. 1 the thruster comprises electric motor enclosed in a waterproof housing 120. The thruster is electrically connected to the ROV through a sealed connector 110. Rotational force is transmitted from the electric motor through a shaft 140 that penetrates the housing 120. Within an embodiment of the invention the shaft 140 is composed of a magnetizable material. Alternatively, the shaft 140 may be composed of two sections, one section is a magnetizable material and the other section is a magnetic material. This embodiment beneficially concentrates the magnetic field around said shaft 140. A shaft seal 130 surrounds a portion of the shaft 140 so as to prevent foreign substances, such as, for example, water, from entering the housing 120.

Now referring to FIG. 2 there is depicted a diagrammatic cross-section of a motor housing 200 according to an embodiment of the invention. The motor housing 210 has an enclosed internal space 250 which contains a motor 260 mounted to the housing 210. In one embodiment, the motor 260 is a low cost, brushed DC motor although it would be evident that other motor designs may be employed. For example, in some embodiments where weight is more important than cost, brushless motors may be used. In another embodiment, the motor 260 includes a gearbox (not shown for clarity). In one embodiment, a REinforced MagnetoRheOlogical Grease (REMROG) shaft seal is stabilized around the motor shaft 230 by a hollow cylindrical permanent magnet 240 which surrounds said motor shaft 230. In another embodiment the permanent magnet may be shaped as a hollow cube as in many instances the exterior shape of the permanent magnet does not significantly affect the operation of the seal but it may impact overall design of the shaft seal 200 and its cost. In another embodiment, a plurality of magnets may be arranged in a hollow cylindrical fashion whilst in another a hollow cylindrical electromagnet surrounding the motor shaft 230 is used. As previously explained, in one embodiment the motor shaft 230 is composed of two sections wherein one is a magnetizable material and the other is a magnetic material. In this embodiment, the magnetic material is orientated so as to reinforce the magnetic fields produced by permanent magnet 240. In this manner the magnetic field is concentrated strongly around motor shaft 230 and the performance of the seal is improved substantially. In some embodiments of the invention a propeller, for example, may be connect to the end of motor shaft 230. Covers 220, placed over the REMROG material to prevent strong physical impacts from displacing the REMROG material.

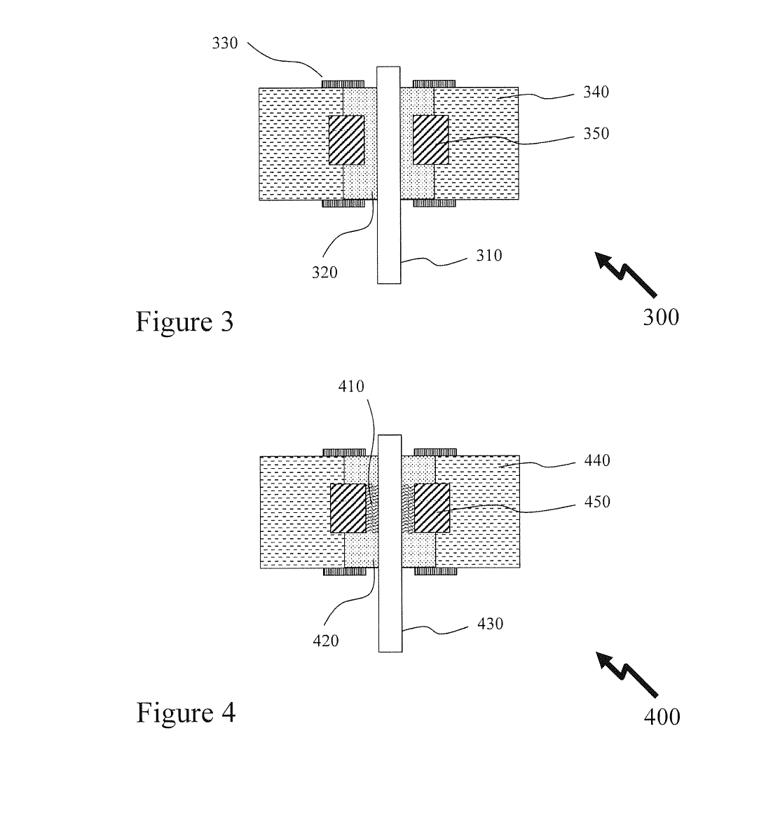

Now referring to FIG. 3 there is depicted a diagrammatic cross-section of a REMROG seal 300 according to an embodiment of the invention as may be employed within surface going marine vessels for example. A motor shaft 310 transfers rotational force through a stabilized REMROG 320. The REMROG 320 is stabilized around the shaft by one or more magnets or electromagnets 350. Disturbances to the REMROG 320 are minimized by protective covers 330. To prevent water from penetrating the hull of the vessel the seal housing 340 must be affixed to the hull in a watertight fashion.

Now referring to FIG. 4 there is depicted a diagrammatic cross-section of a REMROG seal 400 according to an embodiment of the invention with a REMROG 400 with magnetizable fibers 410 is shown. Similar to FIG. 3, a motor shaft 430 transfers rotational force through a REMROG composition comprising a base REMROG 420 with magnetizable fibers 410, which is stabilized around the motor shaft 430 by one or more magnets 450. The one or more magnets 450 may also be one or more electromagnets. To prevent water from penetrating the hull of the vessel the seal housing 440 must be affixed to the hull in a watertight fashion.

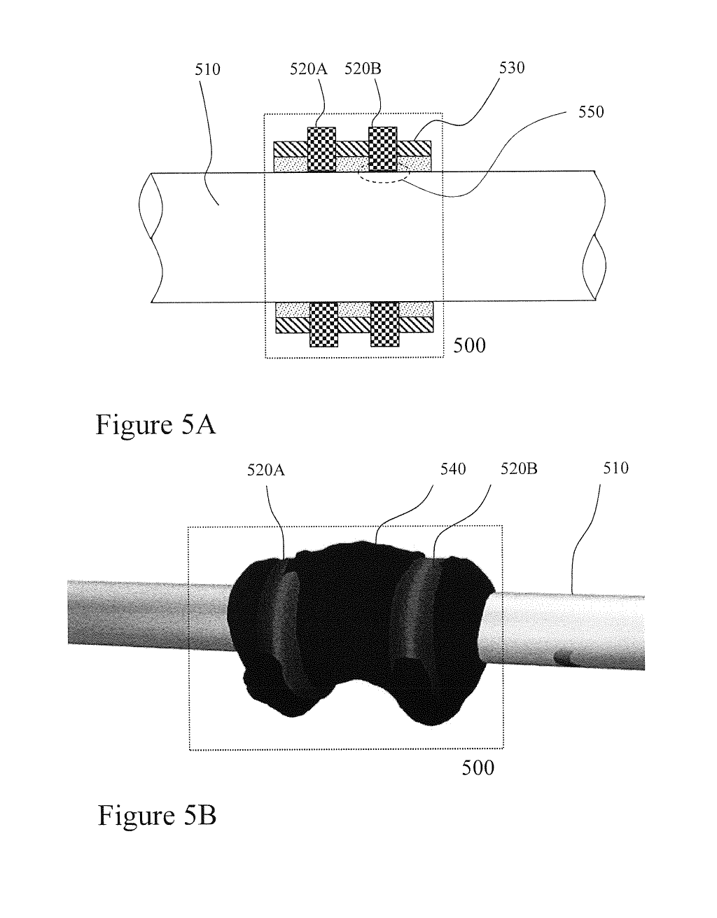

Referring to FIGS. 5A and 5B there are depicted a REMROG basic seal exploiting REMROGs according to embodiments of the invention. As depicted in the cross-section in FIG. 5A and partial perspective view in FIG. 5B a shaft 510 has disposed around it a seal 500. Seal 500 comprising an outer body 530 within which are disposed first and second magnets 520A and 520B respectively. In the cross-section of FIG. 5A the REMROG 540 has been omitted for clarity whilst in the partial perspective view of FIG. 5B the outer body 530 has been omitted for clarity. Accordingly, the REMROG 540 is directed into the gaps 550 between the inner surfaces of the first and second magnets 520A and 520B respectively and the outer surface of the shaft 510. Based upon the tolerance between the inner surfaces of the first and second magnets 520A and 520B respectively and the outer surface of the shaft 510 and the REMROG 540 selected each magnet stage contributes approximately 2-6 psi of pressure resistance (approximately 13.5 kPA-40 kPa).

The larger regions between the inner surface of the outer body 530 and the outer surface of shaft 510 act as reservoirs for the REMROG 540. In this embodiment the first and second magnets 520A and 520B respectively have their poles aligned along the axis of the shaft 510. As a prior art ring magnet has its poles on opposite surfaces rather than the inner and outer surfaces radially then conventional prior art ring magnets may be employed within the basic seal with the REMROG with magnetizable fibers (REMROG-MF) providing an enhanced performance of the prior art at very low cost. However, improved performance with potentially comparable cost or slightly increased cost may be achieved through replacement of each of the first and second magnets 520A and 520B respectively with ring arrays of smaller pill, rectangular, square, etc. cross section magnets such that their poles form the inner and outer surfaces of a segmented ring array.

Accordingly, the REMROG basic seal depicted in FIGS. 5A and 5B is good for low pressure differential applications at low to high revolutions per minute. With respect to the REMROG then low viscosity and low frictions may be employed wherein the addition of reinforcing magnetic fibers increases the pressure rating, especially when there is a gap between the shaft and magnet, thereby allowing for a reduction in manufacturing costs by relaxing tolerances on the shaft outer diameter and magnet inner diameter. Within embodiments of the invention the inventors have found greases can be beneficial due to their shearing behaviour wherein they become liquid along surfaces when/where they are stressed.

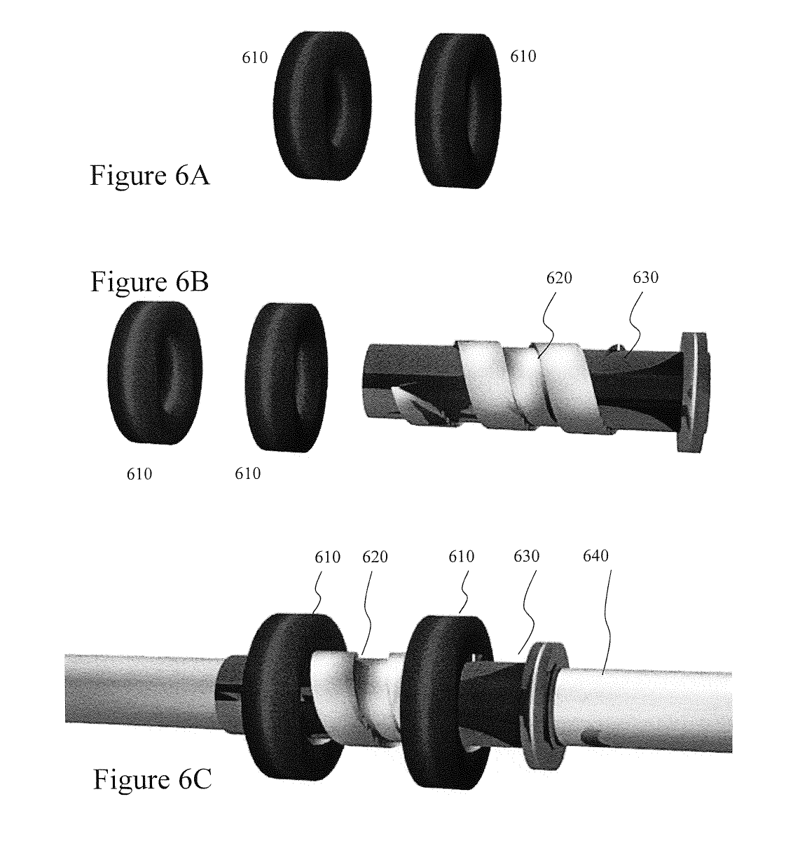

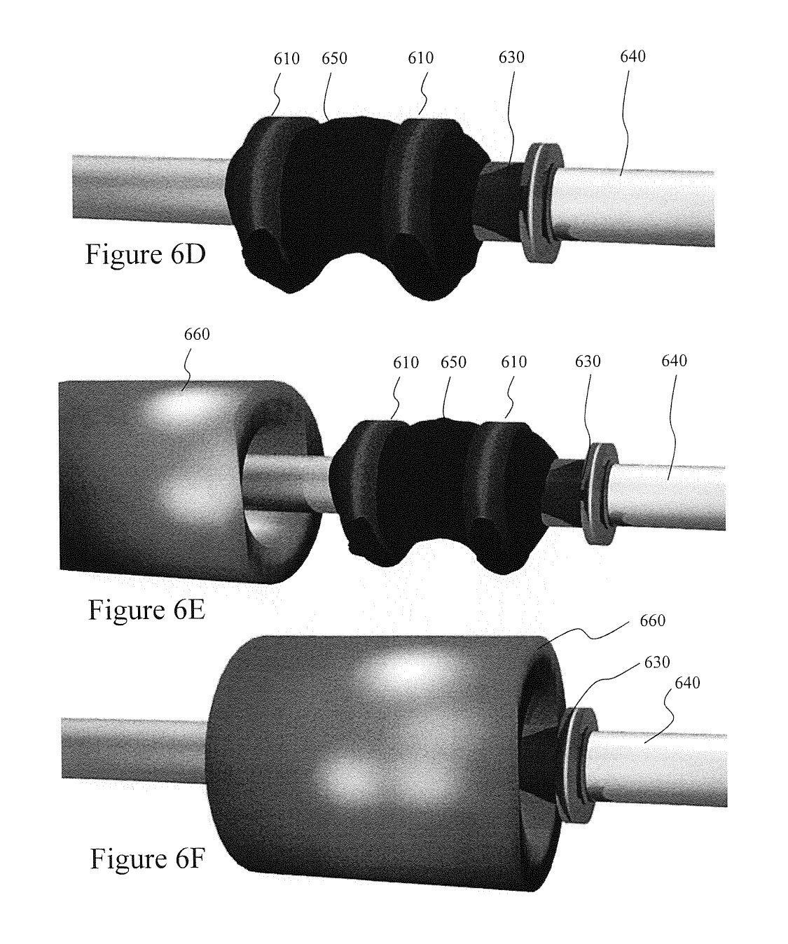

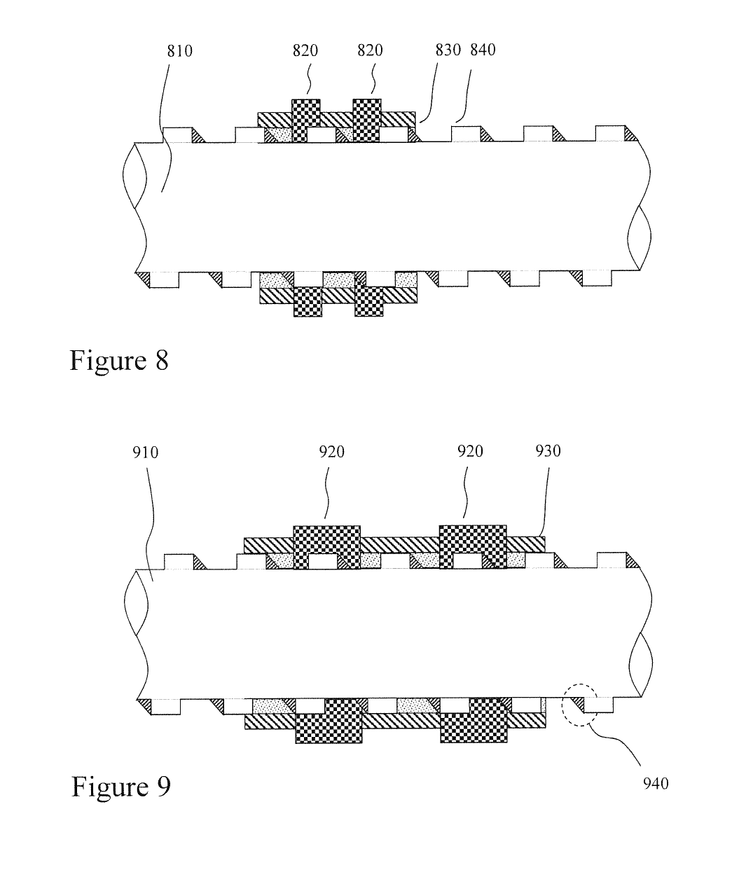

Now referring to FIGS. 6A to 6E respectively there are depicted first to sixth partial perspective images of an improved shaft seal according to an embodiment of the invention, referred to by the inventors as a CWMR seal. As depicted a pair of permanent magnets 610 are disposed around a shaft 640 which has a helical shaft sleeve 630 and a helical sleeve 620 disposed upon its surface. Optionally, the helical shaft sleeve 630 and a helical sleeve 620 may be a single piece-part or dual piece-parts separate to the shaft 640 or they may be integrally formed as part of the shaft 640. Where provided as separate piece-part or piece-parts these are rigidly attached to the shaft 640 so that rotation of the shaft 640 results in the helical shape of the helical sleeve moving relative to each magnet 610. The former allows retrofitting of CMWR seals to existing rotary feed-throughs whilst the latter may be beneficial in other applications. These are all surrounded by REMROG 650 and outer sleeve 660. A cross-section of such a CMWR seal is depicted in FIG. 8 wherein the shaft 640, helical shaft sleeve 630 and the helical sleeve 620 are actually shown as a single piece-part together with the pair of magnets 820 and outer body 830 (e.g. magnets 610 and outer sleeve 660 in FIGS. 6A to 6E respectively).

In operation rotation of the shaft 640 within the CMWR seal results in the helical profile of the helical sleeve 620 rotating relative to the magnets 610 and dragging with it the REMROG 650 pushing it into the lower clearance regions between the outer surface of the helical sleeve 620 and helical shaft sleeve 630 and the inner surfaces of the magnets 610. In most embodiments of the invention it would be beneficial for the helical profile to push the REMROG 650 in the direction opposite to the pressure differential across the CMWR seal. The REMROG 650 may beneficially be a high viscosity paste or gel which is held in the grooves of the helical sleeve 620. The REMROG 650 will pool on the pressure side of the CMWR seal and hence the benefit of “pulling” the REMROG 650 in the opposite direction through rotation of the helical sleeve 630. During operation the inventors have observed the REMROG 650 disappearing from the low pressure side of the CMWR seal. Compared to the seal depicted in FIGS. 5A and 5B the CMWR seal has increased friction, much of it is energy being transferred to the REMROG 650 and pushing against the pressure. REMROG 650 designs with paste like properties have been observed to typically have a higher pressure rating when the shaft is not rotating because their properties are non-Newtonian. These properties also allow the CMWR seal to work both when the shaft rotates and when it doesn't.

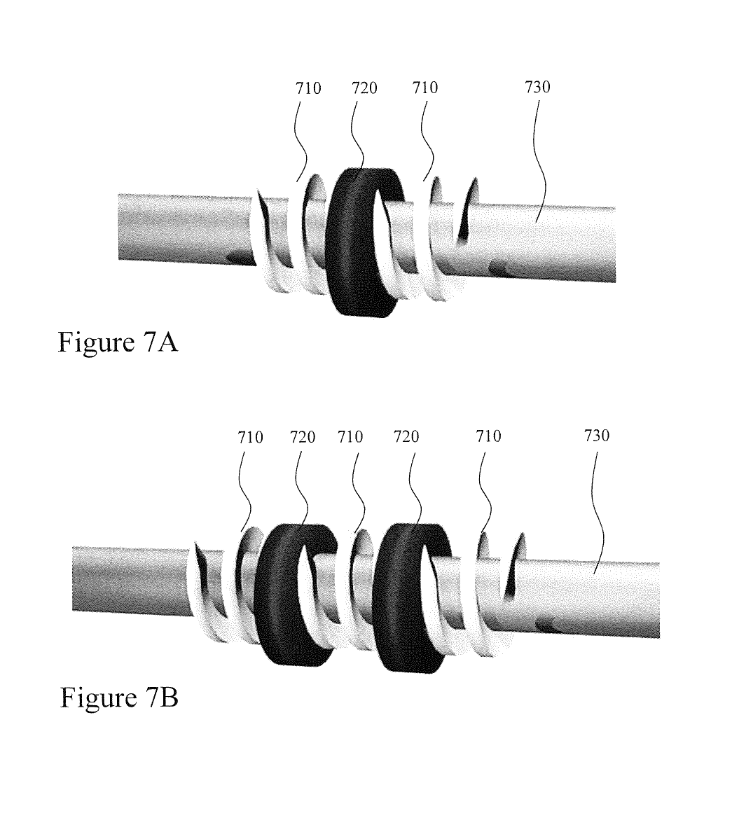

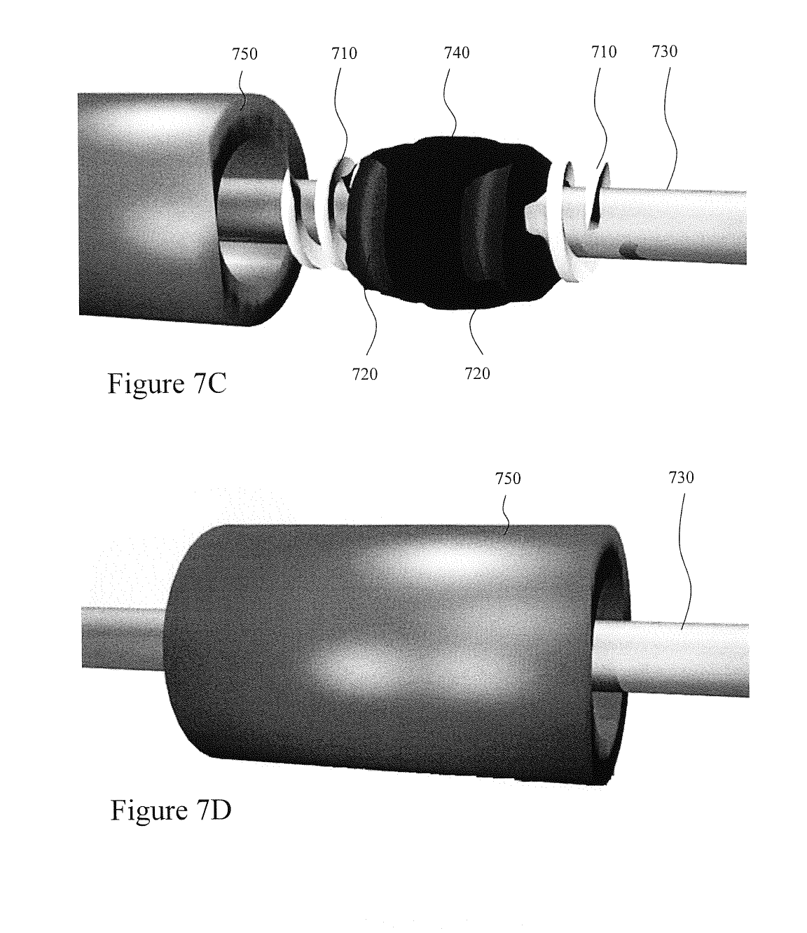

Now referring to FIGS. 7A to 7D respectively there are depicted first to fourth partial perspective images of an improved shaft seal according to an embodiment of the invention, referred to by the inventors as a Helical Housing CWMR (HH-CMWR) seal. As depicted a pair of permanent magnets 720 are disposed around a shaft 730 and have disposed either side and between helical sleeves 710. These are filled with REMROG 740 and the entire assembly is disposed within an outer housing 750. Accordingly, permanent magnets 720 and helical sleeves 710 may be slid over the shaft 730 making retrofitting an easy task once the outer housing 750 has been fixed into position. Optionally, a flange within outer housing 750 limits motion of the first helical sleeve 710 inserted into the other end of the outer housing 750.

In some embodiments of the invention the helical sleeves 710 may have tolerances such that the shaft 730 freely rotates whilst in others they may have an interference fit allowing them to be retained in position or they may be attached to the shaft 730 once located in the correct position such that these rotate relative to the outer housing 750. Within others they may be designed to fit within regions of the outer housing 750 or have interference fit assembly therein such that they are fixed in position whilst the shaft 730 rotates.

In operation the HH-CMWR seal operates on a similar basis to the CMWR seal described supra in respect of FIG. 6 in that the rotation of the shaft and/or helical sleeves 710 through rotation provide a counter pressure force imparting force along the axis of the shaft as the force given by the helix to maintain the REMROG 740 in place between the magnets 720 and shaft 730 against the pressure differential. It would be evident that in embodiments of the invention the helical sleeves 710 disposed between a pair of magnets 720 may be designed differently to each helical sleeve 710 at the outer ends of the HH-CMWR seal. Accordingly, considering the second image in FIG. 7B the spiral on the left hand helical sleeve 710 may be designed to direct REMROG 740 towards left magnet 720 whilst right helical sleeve 710 may be designed to direct REMROG 740 towards right magnet 720. The central helical sleeve 710 may be designed to direct REMROG 740 to both magnets 720. Optionally, the left helical sleeve 710 and the left portion of the central helical sleeve 710 may be designed to provide particular pressure/force to the REMROG under a first set of shaft rotation parameters whilst the right helical sleeve 710 and the right portion of the central helical sleeve 710 may be designed to provide particular pressure/force to the REMROG under a second set of shaft rotation parameters, e.g. opposite rotation, higher speed range, or lower speed range.

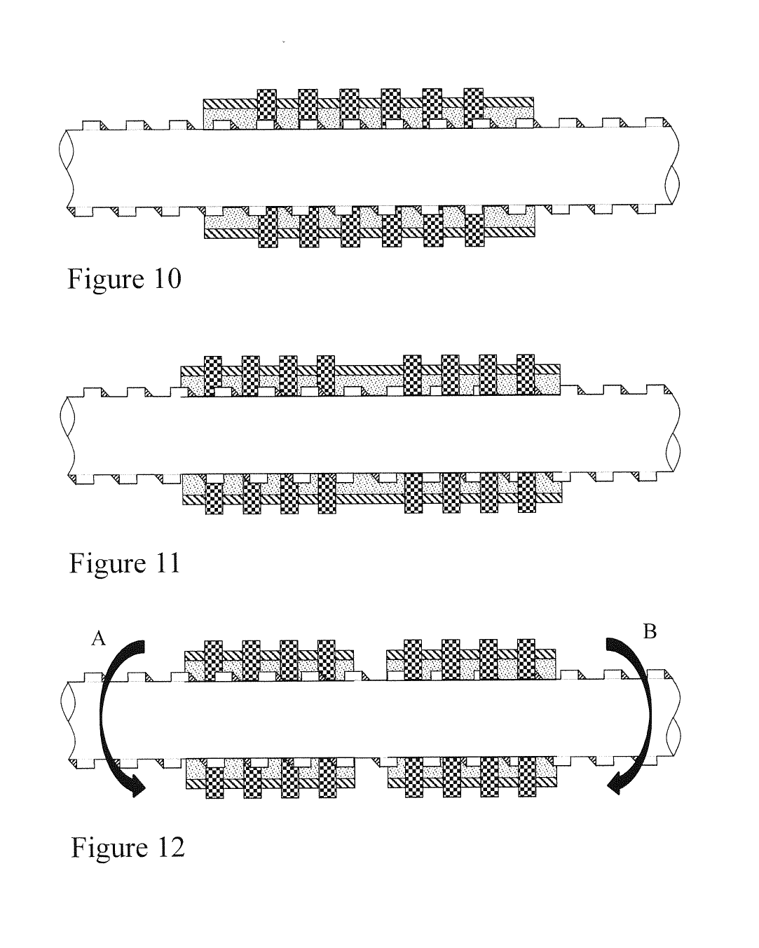

A cross-section of a variant of such a HH-CMWR seal is depicted in FIGS. 8 and 9 wherein the shaft 810/910 and magnets 820/920 are depicted together with an outer body 830/930 which has an inner surface comprising spiraled projections 840/940. FIGS. 8 and 9 depict respectively and more clearly than FIGS. 7A to 7D the profile variation between the two faces of the spiraled projections 940 which is also applicable to the helical sleeves 710. As shown the spiraled projections 940 have a face perpendicular to the axis of the shaft and the other face at an angle relative to the axis of the shaft. Within other embodiments of the invention the REMROG may be “recirculated” in that if there is a net migration of the REMROG through a seal, e.g. a CMWR seal or a HH-CMWR seal for example then a fluid reservoir linking the ends of the seal either side of the magnet array may be employed. Alternatively, a source reservoir may be disposed at the end of the seal from which net migration occurs and a drain reservoir may be disposed at the other end of seal to which net migration occurs. Accordingly, a periodic maintenance would be simply to top up the source reservoir and empty the drain reservoir. It would also be evident that other structures may be employed including, for example, designs with increased magnet count (see FIG. 10 for example), multiple seal arrays within a single outer housing (see FIG. 11 for example), counter-directional seals within a single outer housing (see FIG. 12 for example) wherein one seal is designed to support rotation A of the shaft and the second seal to support rotation B of the shaft.

Within other embodiments of the invention the HH-CWMR seal with helical elements disposed within the outer body of the seal may be used in conjunction with CWMR seals exploiting helical sleeves fitting the shaft of the feed-through or solely helical structures formed within the shaft. Accordingly a shaft with helical projections with a first cross-section, attached via a sleeve or integrally formed, rotate within an outer body comprising helical projections with a second cross-section, either disposed within the outer body or integrally formed within the outer body.

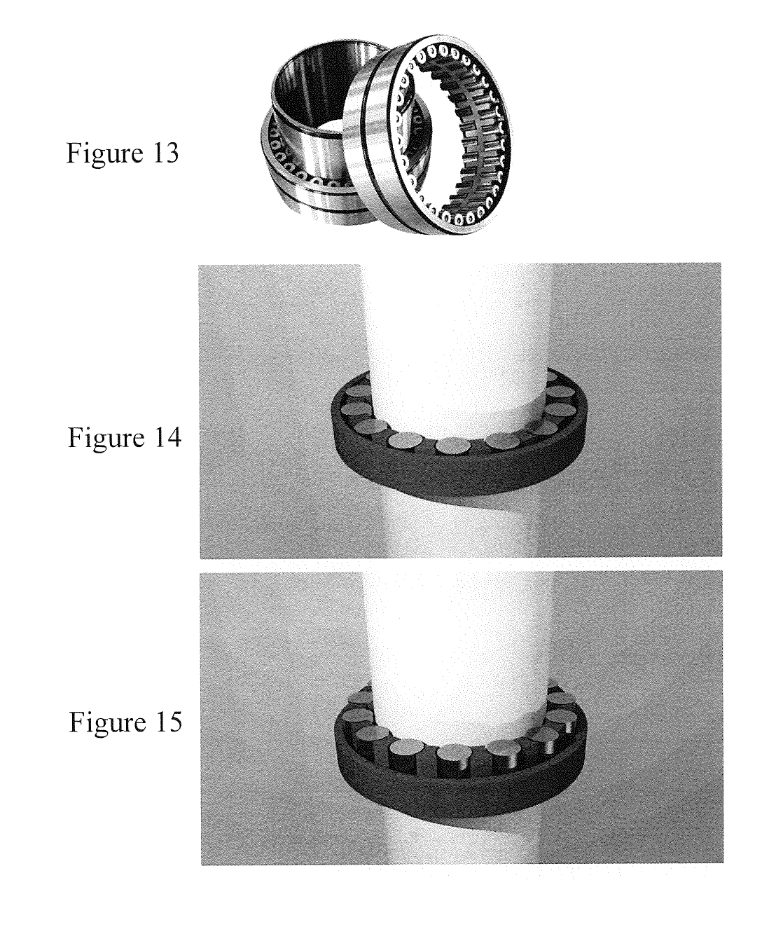

Referring to FIG. 13 there is depicted a traditional cylindrical ball bearing for supporting a shaft and allowing it to rotate through a housing within which the ball bearing and shaft are mounted. Now referring to FIGS. 14 and 15 there is depicted a magnetic cylindrical bearing according to an embodiment of the invention wherein the bearing cylinders are replaced by cylindrical magnets wherein the magnetic bearings would self-lubricate and hold the magnetorheological gel in order to create a seal. In FIG. 15 the outer race has been partially removed to show the placement of the cylindrical magnets within the bearing.

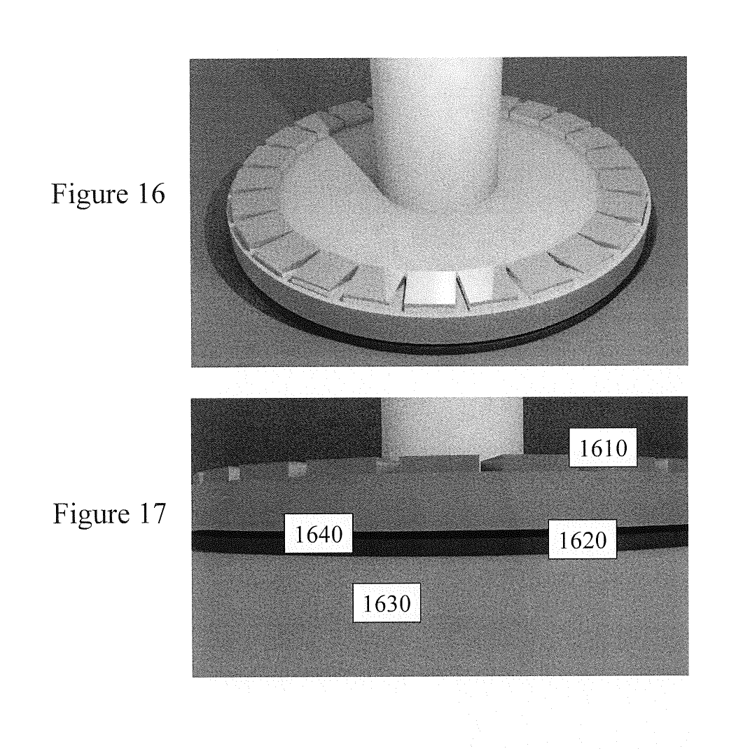

Alternatively, referring to FIGS. 16 and 17 there is depicted a magnetic array and paramagnetic material forming elements of a magnetic seal according to an embodiment of the invention in perspective and close-up side view. FIG. 17 depicting the gap between the magnet array and paramagnetic material within the design of FIG. 16 where the magnetorheological gel will be attracted. Accordingly, as depicted n ring shaped array of magnets or a single ring magnet (or magnet ring segments) are statically attached to a rotating shaft. The magnet array spins with the shaft in proximity of a paramagnetic material (e.g. steel) or another magnet ring. The magnetorheological gel is attracted to the gap between the magnet ring and the paramagnetic material (or other magnet) thereby forming a seal. It would be evident that different configurations could have either the magnet array or the paramagnetic material attached to the shaft. In some embodiments of the invention a sacrificial material such as PTFE or ball bearings could be used to maintain the separation of the two rings.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A seal comprising:
a magnetorheological grease established by mixing a semisolid lubricant and a plurality of macro-magnetizable particles.

2. The seal according to claim 1, wherein
the magnetorheological grease further comprises a magnetorheological fluid.

3. The seal according to claim 1, wherein
the semisolid lubricant comprises a plurality of semisolid lubricants.

4. The seal according to claim 1, further comprising:
an outer body through which the shaft is designed to fit comprising an inner surface and an external surface, the inner surface comprising a plurality of helical projections with predetermined cross-section; and
a magnet disposed within a predetermined position within the outer body, the magnet for radially encompassing the shaft.

5. The seal according to claim 1, further comprising:
an outer body through which the shaft is designed to fit comprising an inner surface and an external surface;
a magnet disposed within a predetermined position within the outer body, the magnet for radially encompassing the shaft; and
a helical sleeve having an outer surface comprising a plurality of helical projections with predetermined cross-section.

6. The seal according to claim 5, wherein
the helical sleeve has an inner surface through which the shaft fits and is fitted to the shaft when
the seal is assembled onto the shaft.

7. The seal according to claim 5, wherein
the helical sleeve is integrally formed within the shaft.

8. A seal for a shaft comprising:
an outer body through which the shaft is designed to fit comprising an inner surface and an external surface, the inner surface comprising a plurality of first helical projections with a first predetermined cross-section;
a helical sleeve having an outer surface comprising a plurality of second helical projections with a second predetermined cross-section;
a magnet disposed within a predetermined position within the outer body, the magnet for radially encompassing the shaft; and
a magnetorheological grease.

9. The seal according to claim 8, wherein
the magnetorheological grease is formed by mixing a semisolid lubricant, a magnetorheological fluid, and a plurality of macro-magnetizable particles.

10. The seal according to claim 8, wherein
the magnetorheological grease is formed by mixing a semisolid lubricant and a plurality of macro-magnetizable particles.

11. The seal according to claim 8, wherein
the helical sleeve has an inner surface through which the shaft fits and is fitted to the shaft when the seal is assembled onto the shaft.

12. The seal according to claim 8, wherein
the helical sleeve is integrally formed within the shaft.

13. A seal for a shaft comprising:
a first body through which the shaft is designed to fit and to which the shaft is attached and having a first surface perpendicular to the shaft and a second surface disposed perpendicular to the shaft;
a second body through which the shaft is designed to fit having a third surface perpendicular to the shaft and disposed such that a gap exists between the third surface and the first surface of the first body, a predetermined portion of the second body comprising at least one of a magnetic material and a paramagnetic material and subtending a first predetermined portion of a circumference of the shaft;
a first magnet disposed on the second surface of the first body such that a magnetic field between the first magnet and the predetermined portion of the second body is aligned along the axis of the shaft and subtending a second predetermined portion of the circumference of the shaft; and
a magnetorheological grease filling the gap.

14. The seal according to claim 13, wherein
the magnetorheological grease is formed by mixing a semisolid lubricant, a magnetorheological fluid, and a plurality of macro-magnetizable particles.

15. The seal according to claim 13, wherein
the magnetorheological grease is formed by mixing a semisolid lubricant and a plurality of macro-magnetizable particles.

16. The seal according to claim 13, wherein
the first magnet is a plurality of magnets radially disposed.
